(19) United States
(12) Patent Application Publication
(10) Pub. No.: US 2003/0145709 A1
(43) Pub. Date: Aug. 7, 2003

(54) Woodworking machine

(76) Inventor: Tom R. Flader, Fond du Lac, WI (US)

Correspondence Address: R. Jonathan Peters, 3169 Ryf Road, Oshkosh, WI, 54904, US

(21) Appl. No.: 10/061,879

(22) Filed: Feb. 4, 2002

(51) Int. Cl. B27B 13/00; B23D 53/00; B23D 55/00

(52) U.S. Cl. 83/788; 83/821

(57) ABSTRACT

For a woodworking machine having a horizontally disposed working table and a bandsaw blade transverse to the table, there is provided an elongated fence having a substantially rectangular cross-section mounted perpendicular to the table and spaced from the saw blade and parallel to the line of the saw blade. The fence has a clamp including (a) a downwardly disposed projection at about one end of the fence adaptable for engaging an edge of the table, and (b) a pivotal member downwardly disposed from the fence at about the opposite end thereof and adaptable for engaging an opposite edge of the table. The projection is adjustable linearly relative to the fence to bring the projection and the pivotal member into fast engagement with opposed edges of the table. The pivotal member includes locking screw for locking the fence in a selectively pivotal position.

### FIELD OF THE INVENTION

This invention relates to a bandsaw woodworking machine. In its more specific aspect, this invention relates to a bandsaw woodworking machine utilizing a fence adjustable for a selectively pivotal position.

### BACKGROUND OF THE INVENTION

For general woodworking purposes, a band saw having an endless saw blade is useful in the woodworking shop, particularly for the home work shop. These band saws are versatile, adaptable, compact, and relatively safe. A rectangular fence having a planar facing, which is parallel to and spaced from the saw blade, is used to guide the work piece. However, a known and common problem with the endless saw blade is that the angle the blade wants to cut is not true in that the blade does not track exactly perpendicular to the front edge of the saw blade. An inordinate amount of time can be spent trying to fine-tune the bandsaw blade, and additionally work pieces can be lost or scraped.

This invention has therefore as its object to provide a fence for a band saw machine that is adjustable for a selectively pivotal position.

### SUMMARY OF THE INVENTION

Broadly, the invention provides an improved woodworking machine having a horizontally disposed working table and a saw blade transverse to the table and utilizing an elongated fence that is selectively positioned to allow for any drift. The term “fence” is sometimes referred to in the art as a “rip fence,” and it is understood that the two terms as used herein and in the appended claims, are synonymous. The fence has a planar facing disposed perpendicular to, parallel with, and adjustably spaced from the saw blade. Preferably, the fence is substantially rectangular as viewed in transverse cross-section, and the fence, along its longitudinal axis, is mounted perpendicular to the table. The fence is provided with a clamping means including (a) a downwardly disposed projection at about one end adaptable for engaging an edge of the table (usually the rear edge relative to the position of the workman), and (b) a pivotal member downwardly disposed at about the opposite end of the fence adaptable for engaging an opposite edge of the table (the front edge relative to the position of the workman). The projection is adjustable linearly relative to the fence to bring the projection and the pivotal member into fast engagement with opposed edges of the table. The pivotal member, which is integral with the fence, includes a suitable means for locking the fence in a selectively pivotal position.

In a preferred embodiment of my invention, the fence has a longitudinal slot, and an actuating shaft is rotatably mounted in the slot. A slide member is disposed in the slot and is operably connected to the shaft, and a projection is integrally with and depends downwardly from the slide member. Preferably, the shaft is threaded, and the slide member is provided with complementary threads. Thus, actuation or rotation of the shaft causes longitudinal movement of the slide to bring the projection into engagement with an edge of the table (usually the rear edge relative to the position of the workman). The pivotal member may be a brace having a flat facing adaptable to abut flush with the opposite edge (front edge) of the table. Thus, the projection and the brace provide a clamping means to provide for fast engagement of the fence with opposed edges of the table, and the pivotal member includes means for locking the fence in a selectively pivotal position.

### BRIEF DESCRIPTION OF THE ACCOMPANYING DRAWINGS

The invention and its advantages will be more readily understood by reference to the following detailed description and exemplary embodiments when read in conjunction with the following drawings, wherein:

FIGS. 1 is a broken perspective view of a typical band saw machine showing a horizontal table and a vertical, endless saw blade and utilizing the fence of my invention.

FIG. 2 is a perspective view of the fence of my invention.

FIG. 3 is a side elevational view of the fence of FIG. 2.

FIG. 4 is an end view of the fence of FIG. 3.

FIG. 5 is a side elevational view of the fence of FIG. 3 partially broken away to show in more detail certain features of the invention.

FIG. 6 is a plan view as seen from the bottom of the fence of FIG. 3.

### DETAILED DESCRIPTION OF THE INVENTION

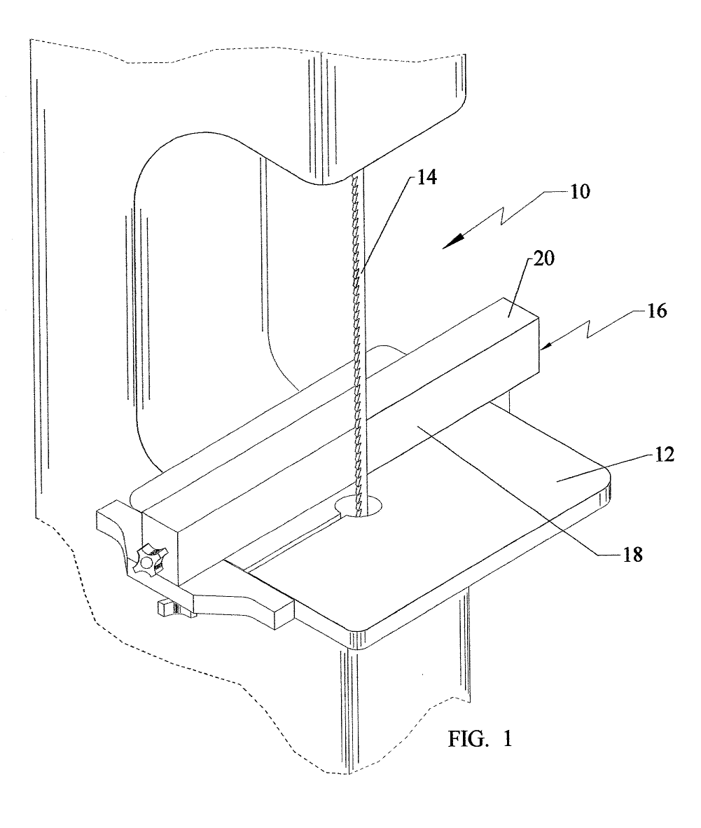

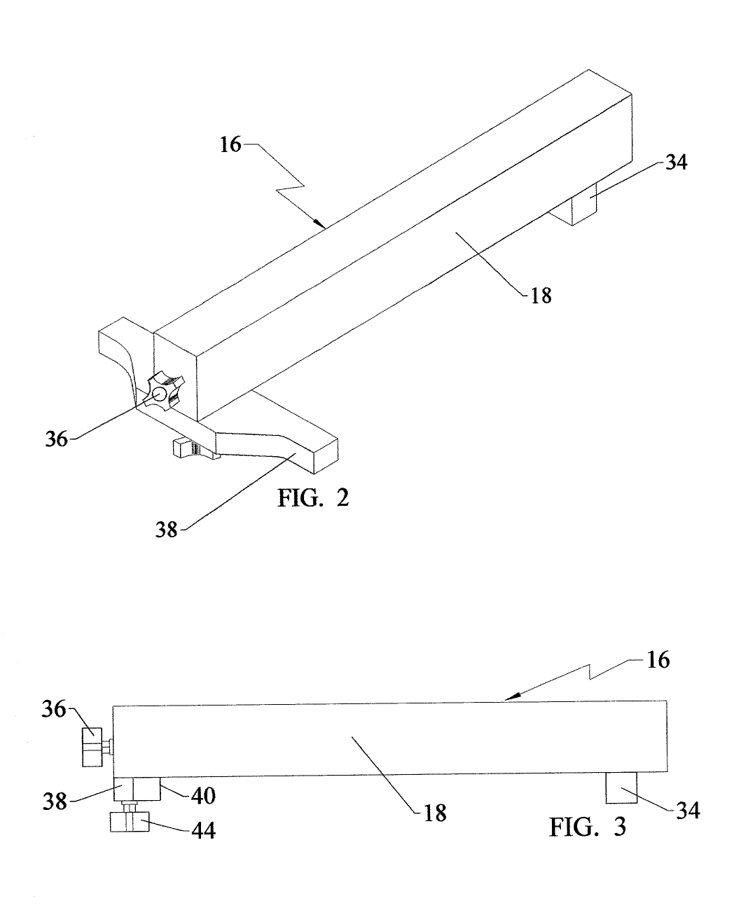

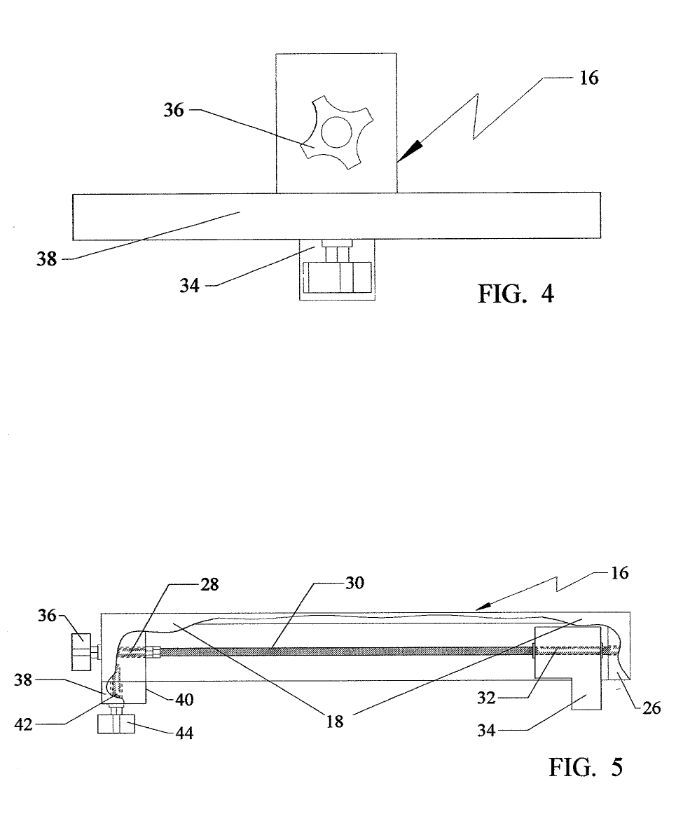

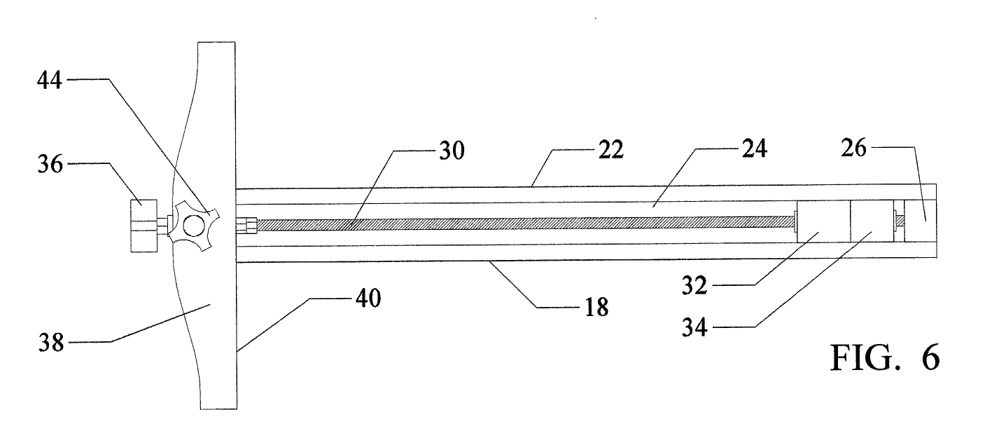

In referring to the drawings, wherein like reference numerals designate similar parts throughout the several views, there is illustrated in FIG. 1 a typical wood working machine, generally indicated by the numeral 10, having a horizontally disposed working table 12 and using a vertical, endless bandsaw blade 14 with a suitable motor means (not shown) for driving the saw blade. An elongated fence 16, having a substantially rectangular configuration as viewed in transverse cross-section, is seated on the working table 12 and has a plan surface 18. The fence can be of any desirable material such as wood, metal, or plastic, or a combination of materials. The longitudinal axis of the fence is parallel with the line of the saw blade, and when mounted, is perpendicular to the table and is spaced from the saw blade and parallel to the line of the saw blade.

The fence 16 is provided with a suitable clamping means which includes an adjustable member and a pivotal member, so that the clamping means can be adjusted to engage the table at opposed edges to secure the fence and hold it fast in the desired position. It will be observed that the fence 16 includes a top 20 and downwardly depending, parallel side walls 22 thereby forming a longitudinal slot 24. Transverse end walls 26 and 28 are at opposed ends of the slot 24. A threaded shaft 30 is mounted in the slot 24 and is supported at opposite ends by the transverse walls 26 and 28, and the shaft 30 is free to rotate but not be translated linearly. At about one end of the fence there is provided a slide member 32 disposed in the slot inwardly of the wall 28, and the slide member is operably connected to the shaft 30. A projection 34 is integral with and depends downwardly from the slide member so as to protrude outwardly from the slot. The shaft is threaded, and the slide member is provided with complementary threads. Thus, actuation or rotation of the shaft by knob 36 causes the longitudinal or linear movement of the slide member so as to bring the projection into or out of engagement with an edge (i.e. rear edge) of the table.

In a preferred embodiment of the invention, the pivotal member may be a brace 38 having a flat or planar facing 40 adaptable to abut flush with the opposite edge (i.e. front edge) of the table. A pivotal pin 42, desirably having a turning knob 44 or the like for ease of turning, is arranged at about the midpoint or center of the brace 38 and extends through the brace and into the transverse wall 28 of the fence. Thus, the projection 34 and the brace 38 provide a clamping means to provide for fast engagement of the fence with opposed edges of the table, and the pivotal member includes the suitable knob 44 for locking the fence in a selectively pivotal position, as described below.

In a bandsaw set-up for the practice of my invention, typically starting with a fresh saw blade and clean machine parts, the fence is adjusted for drift as follows:

A pencil line is drawn parallel to a straight edge on a piece of scrap wood approximately as long as the bandsaw table is deep. The piece of scrap wood is cut on the bandsaw along the pencil line until the back edge of the wood reaches the rear of the bandsaw table. Typically, the wood piece will not feed through the blade perfectly parallel to the bandsaw blade, which creates the problem my invention remedies. The straight edge of the wood piece is now at the angle of the drift for that particular blade. While holding the wood piece securely to the table at this angle, the fence is placed against the straight edge of the wood, and the adjustable angle brace 38 is secured so that it fully contacts the front of the bandsaw table. The fence is now in proper adjustment for that particular blade. This angle will stay generally the same for the life of the blade, although occasionally the fence will have to be reset as the blade wears.

It will be observed that the fence apparatus of my invention provides for several advantages, including the fact that the apparatus is not complicated to use and requires no special or unusual skill. An adjustment to the fence for a selectively pivotal position is easily achieved with the device of my invention. Further, it should be understood that the foregoing detailed description has been given for clearness of understanding only, and no unnecessary limitations should be understood therefrom, as modifications will be obvious to those skilled in the art.

What is claimed is:

1. In a woodworking machine having a horizontally disposed working table and a saw blade transverse to the table, comprising: an elongated fence having a planar facing disposed substantially perpendicular to the table and spaced from the saw blade and parallel to the line of the saw blade; said fence having a clamping means including (a) a downwardly disposed projection at about one end adaptable for engaging an edge of the table, and (b) a pivotal member downwardly disposed at about the opposite end of said fence and adaptable for engaging an opposite edge of the table; said projection adjustable linearly relative to said fence to bring said projection and said pivotal member into fast engagement with opposed edges of the table; and said pivotal member including means for locking said fence in a selectively pivotal position.

2. In a woodworking machine according to claim 1 wherein said fence has a longitudinal slot, an actuating shaft rotatably mounted in said slot, a slide member disposed in said slot and operably connected to said shaft, and said projection being integral with and depending downwardly from said slide member, whereby rotatable movement of said shaft causes longitudinal movement of said slide to bring said projection into engagement with an edge of the table.

3. In a woodworking machine according to claim 1 wherein said pivotal member comprises a brace having a flat facing adaptable to abut flush with an edge of the table

4. In a woodworking machine according to claim 3 wherein said brace has a centrally located pivot pin extending from said brace into said fence, and means for locking said brace in a desired position.

5. In a woodworking machine having a horizontally disposed working table and a saw blade transverse to the table, comprising: an elongated fence having a longitudinal slot and a planar facing disposed substantially perpendicular to the table and spaced from the saw blade and parallel to the line of the saw blade; an actuating shaft rotatably mounted in said slot, a slide member disposed in said slot and operably connected to said shaft, and a projection at about one end of said fence being integral with and depending downwardly from said slide member and adaptable for engaging an edge of the table; and a pivotal member downwardly disposed at about the opposite end of said fence and adaptable for engaging an opposite edge of the table; said projection adjustable linearly relative to said fence to bring said projection and said pivotal member into fast engagement with opposed edges of the table; and said pivotal member including means for locking said fence in a selectively pivotal position.
